(19) United States
(12) Patent Application Publication
(10) Pub. No.: US 2023/0308872 A1
(43) Pub. Date: Sep. 28, 2023

(54) SYSTEM AND METHOD FOR TRANSFERRING DATA BY DATA PACKETS

(71) Applicant: Ford Global Technologies, LLC, Dearborn, MI (US)

(72) Inventors: Joseph Andreas Urhahne, Pulheim/NRW (DE); Frederic Christen, Hergenrath/Liege (BE)

(73) Assignee: Ford Global Technologies, LLC, Dearborn, MI (US)

(21) Appl. No.: 18/185,491

(22) Filed: Mar. 17, 2023

(30) Foreign Application Priority Data
Mar. 22, 2022 (DE) 10202210674.6
Jun. 8, 2022 (DE) 102022114438.0

(51) Int. Cl. H04W 12/06; H04L 69/22; H04W 4/40; G08G 1/0967

(52) U.S. Cl. CPC H04W 12/06; H04L 69/22; H04W 4/40; G08G 1/096708; B60W 2556/45; B60W 10/04

(57) ABSTRACT

A system for transferring data via data packets includes a data transfer transceiver and a plurality of vehicles, the vehicles in each case having an on-board data receiver for receiving data packets transmitted by the data transfer transceiver. In order to enable a lighter bandwidth load in the data transfer, shorter computing times and lower computing capacities, the data transfer transceiver is configured to transmit the data packets by way of a broadcast transmission to the on-board data receivers of the plurality of vehicles.

### CROSS-REFERENCE TO RELATED APPLICATION

This patent application claims priority to German Application No. DE 10202210674.6 filed on Mar. 22, 2022, and German Application No. DE 102022114438.0 filed Jun. 8, 2022, both of which are hereby incorporated by reference in its entirety.

### BACKGROUND

The present disclosure relates to a system for transferring data via data packets, including a data transfer transceiver and a plurality of vehicles, the vehicles in each case having an on-board data receiver for receiving data packets transmitted by the data transfer transceiver. The present disclosure further relates to a data transfer transceiver, a vehicle including an on-board data receiver, and an on-board data receiver for use in a system of this type. Finally, the present disclosure relates to a method for transferring data with data packets from a data transfer transceiver to a plurality of vehicles.

Ongoing developments in the domain of networked data communication are having an increasing effect on the motor vehicle sector, particularly in the domain of “autonomous driving”. “Autonomous driving” will essentially play an increasingly important role in current and future vehicle developments. A substantial part of current developments concerns the interaction of autonomously operated vehicles and their environment. The development of efficient data transmission systems making sparing use of computing capacity are therefore of great interest.

In autonomously or remotely operated vehicles, communication (inter alia data transfer) normally takes place with their environment, for example infrastructure units of an infrastructure system, using point-to-point data transfer, i.e., a single vehicle receives a data packet transmitted by a data transfer transceiver (for example, a radio of an infrastructure unit). If more than one vehicle is intended to receive messages from a data transfer transceiver, a plurality of point-to-point connections must be provided between the respective vehicles and the data transfer transceiver.

Solutions of this type often result in a high bandwidth load for those data transfer connections provided between the data transfer transceiver and the individual vehicles. The transferred data packets comprise data packet headers with administrative information and security information in order, for example, to protect the respective data transfer connection against cyber attacks.

Such a subheader of a data packet geared towards security information can comprise a substantial volume of data (for example 300 bytes) which have to be transferred with each message transmitted from the data transfer transceiver to a single vehicle. In applications having a plurality of data transfer transceiver-to-vehicle connections (e.g. a central data transfer transceiver which transfers data to a plurality of vehicles which, for example, can belong to a vehicle fleet or transport fleet), the volume of data to be transmitted increases with each additional vehicle, since the corresponding data packets have to be transmitted individually using a single data transfer between the data transfer transceiver and the respective vehicles.

Along with the considerable volume of data to be transmitted, a transmission of data packets of this type requires substantial computing times and computing capacities on the part of the data transfer transceiver.

### BRIEF DESCRIPTION OF THE DRAWINGS

FIG. 1 shows a system for conventionally transferring data using data packets.

FIG. 2 shows a system for transferring data using data packets according to the present disclosure.

FIG. 3 shows a schematic structure of a data packet which is transferred with a system formed according to the present disclosure.

FIG. 4 shows a schematic structure of a response data packet.

FIG. 5 shows a schematic structure of a data packet together with data containers.

### DETAILED DESCRIPTION

An aspect of the present disclosure is to provide a system for transferring data using data packets between a data transfer transceiver and a plurality of vehicles, wherein the system requires a lower bandwidth load in the data transfer, shorter computing times and lower computing capacities. A corresponding aspect forms the basis of the data transfer transceiver disclosed herein, the disclosed vehicle, the disclosed on-board data receiver and the disclosed method.

In one or more implementations, a system for transferring data using data packets may include a data transfer transceiver and a plurality of vehicles, said vehicles in each case having an on-board data receiver for receiving data packets transmitted by the data transfer transceiver. The system is characterized in that the data transfer transceiver is configured to transmit the data using a broadcast transmission to the on-board data receivers of the plurality of vehicles.

A “vehicle” can be understood here to mean a wheel-bound motor vehicle (e.g. a passenger vehicle or a utility vehicle), but also any other vehicles, such as agricultural vehicles, construction vehicles, forklift trucks, commercial vehicles, transport vehicles, rail vehicles, aircraft (e.g. drones), watercraft, etc. A “vehicle” can have any drive, for example an electric drive, an internal combustion engine, a diesel engine, a hybrid drive, a hydrogen drive, a gas drive, etc. In particular, a “vehicle” can be understood here to mean an autonomous driving vehicle. Other mobile units (e.g. robotic units) can be regarded as a “vehicle”.

The aforementioned “plurality of vehicles” can relate to a closed group of vehicles (e.g., a transport fleet, a vehicle fleet, a number of vehicles of a logistics center, a number of vehicles within a predefined area (e.g., a parking garage or industrial site), or the like). In particular, the “plurality of vehicles” can relate to a production site (a works) of a vehicle manufacturer, for example the plurality of vehicles can have been newly manufactured on the manufacturing site (new vehicles). In these cases, the present disclosure relates to a control of an autonomous driving operation of the vehicles in the predefined area (e.g., industrial site, manufacturing site, etc.).

The vehicles can receive data and information for an autonomous driving operation using the aforementioned broadcast transmission of data packets from the data transfer transceiver to the on-board data receiver of the plurality of vehicles. It can be provided that the vehicles receive the data and information necessary for autonomous driving exclusively using the broadcast transmission without the need to use on-board sensors (e.g., radar, lidar, GPS, or ultrasound sensors) of the vehicles. In addition to the data and information required for autonomous driving and transferred using broadcast transmission, it can further be provided that the autonomous driving is also based on data and information which are determined by on-board sensors (e.g., radar, lidar, GPS, or ultrasound sensors) of the vehicles.

The designated data and information which are transmitted using a broadcast transmission from the data transfer transceiver to the on-board data receiver can relate to data and information which are determined using sensors in the environment of the vehicles (i.e., outside the vehicles). These sensors can be referred to as infrastructure sensors. A current vehicle position, speed, change of speed, direction of travel, etc., of the vehicles can be determined at any time using such sensors. Data and information required for autonomous driving, i.e., data and information which relate to the future autonomous driving of the vehicles to the next waypoint on a route, can be determined on this basis. The data and information determined by the infrastructure sensors can, for example, be collected in the data transfer transceiver (or elsewhere) and can be transmitted in a common data packet to the on-board data receivers. The infrastructure sensors are therefore preferably connected to the data transfer transceiver using a signaling or data transfer connection (in particular wirelessly). Alternatively, individual infrastructure sensors can be connected using a signaling or data transfer connection to a respective data transfer transceiver and can therefore transmit the data and information determined the respective infrastructure sensor as a data packet or data packets via the respective data transfer transceiver to the vehicles using a broadcast transmission. The data processing and determination of driving information relating to the autonomous driving of a respective vehicle can then take place on board the vehicle, e.g., in an on-board computer.

The data and information transferred by the data transfer transceiver can also relate to individual route points or to a sequence of route points of a route to be travelled by the vehicle. The transferred data and information can relate to map data. The route information can also be calculated in the vehicle, for example in an on-board computer. In this case, the map data can already be present on the on-board computer. The current location of the vehicle and the measures required to activate the next route point can be determined on board the vehicle on the basis of the transferred data and information.

The “data transfer transceiver” can be a central data transfer transceiver, i.e., a data transfer transceiver which can transmit data using data packets to a plurality of vehicles. The data can be transmitted automatically or manually. The data transfer transceiver can be operated with a computer or can be part of a computer. Within the meaning of the present disclosure, the data transfer transceiver can be a single (central) data transfer transceiver, or a data transfer transceiver can equally consist of a plurality of data transfer sub-transmitters which are arranged at different locations in the area (e.g. industrial site, manufacturing site).

An “on-board data receiver” is understood to mean a data receiver with which data transmitted by the data transfer transceiver can be received. “On-board” further means that the data receiver is part of the vehicle, i.e. is arranged in or on the vehicle or on a component thereof. The data receiver can be integrated with an on-board computer of vehicle or can have a signaling connection thereto, such as over a CAN network of the vehicle.

With a system of this type, a broadcast connection is provided instead of the aforementioned point-to-point data transfer connections between a (central) data transfer transceiver (e.g., radio of an infrastructure unit) as the transmission source and the vehicles as receiving sources. This means that a data packet (e.g., a message) transmitted by the data transfer transceiver is addressed to a plurality of vehicles as receiving sources and is received by said vehicles. The information on which the data packet is based is dispatched once only, which can reduce the bandwidth load, makes sparing use of the computing capacity of the data transfer transceiver, and reduces the computing time thereof. A data packet of this type dispatched by a broadcast transmission can comprise a data packet header (also called header information) which preferably has the same size as a corresponding data packet header of a data packet transmitted to a single vehicle (as described in the background and known from the prior art).

A data packet of this type can further have a data packet message body (also referred to as payload data) which comprises information (e.g., a message text) in order to address a plurality of vehicles simultaneously with instructions or commands, for example for specific autonomous driving maneuvers or route information. As mentioned, data and information previously determined using infrastructure sensors in the environment of the vehicle can be forwarded to the vehicles using the data packet message body. The aforementioned infrastructure sensors can, for example, be one or more cameras, lidar sensors, radar sensors, infrared sensors and/or laser sensors. These infrastructure sensors are arranged outside the vehicles, for example within a predefined area. As mentioned, individual route points or a sequence of route points of a route to be travelled by the vehicle can also be transferred to the vehicles using the data packet message body.

The present disclosure is useful in the domain of autonomous driving vehicles, in particular autonomous driving at low speeds. One possible application/function can be “depot marshalling” which is proposed for the automation of driving processes in delivery depots. It increases the efficiency of vehicle movements as it relieves delivery drivers of the task of controlling the vehicles on the premises of a depot, including loading and unloading goods, charging batteries at a charge point, finding a parking space for breaks and overnight stays, driving into car wash installations, etc. The driver can park a vehicle e.g., in a drop-off zone and retrieve it after a certain time in the depot, e.g., in a pick-up zone, without having to enter the indoor areas of the depot. A system according to the present disclosure can be used directly in “depot marshalling” of this type, wherein corresponding information relating to vehicle movements, a traffic situation in the depot, goods receiving and loading tasks, goods dispatching and unloading tasks, loading status of loading stations, parking lot occupancies, etc., can be transmitted using a broadcast transmission from a (central) data transfer transceiver (saving on computing capacity, saving on computing time, and having a low bandwidth load) to the vehicles associated with the depot. This information can be taken into account by the (autonomous) vehicles in the execution of driving maneuvers, driving routes, etc.

A further field of application of the present disclosure relates to “factory marshalling”, wherein, in a works where vehicles are manufactured, assembled or processed, said vehicles can be moved around the works site/manufacturing site using autonomous driving. Human effort required to move the vehicles from one location to the next can thus be significantly reduced.

The data packets can be transferred on the basis of all data transfer methods suitable for the data transfer between the data transfer transceiver and the vehicles (e.g., the on-board data receivers). The communication can be near-field, medium-field or far-field communication. In particular, data transfer based on a geo-network such as C-V2X-PC5 can be considered. C-V2X (Cellular Vehicle-to-Everything) is a radio technology which is used in autonomous driving and in intelligent traffic systems (ITS). PC5-based C-V2X uses an RF (Radio Frequency) sidelink direct communication for low-latency, usage-critical vehicle sensor connectivity. The mobile radio network itself can further be used as a transmission medium for the data transfer between the data transfer transceiver and the vehicles (e.g., the on-board data receivers), said mobile radio network comprising either public or private parts of mobile radio cells which are also referred to as a cellular Uu link. It should be emphasized that response data packets can also be transmitted back using these data transfer facilities, i.e., from an on-board data transmitter to a data receiver as part of the data transfer transceiver. A response data packet can be transmitted in response to receiving a received data packet.

The data transfer can essentially be radio-based, wherein suitable radio standards can be WLAN (IEEE 802.11), Bluetooth (IEEE 802.15.1), 5G (3GPP Release 15), 4G or LPWAN (Low Power Wide Area Network). WirelessHART (IEC 62591) or Sigfox (Sigfox Proprietary) can also be used. Generally speaking, any type of mobile data transmission technology which is suitable for broadcast data transfer can be considered.

A Bluetooth connection is an industry standard according to IEEE 802.15.1 for short-distance data transmission using a radio signal.

WIFI, also known as wireless LAN (WLAN) according to IEEE 802.11, similarly refers to data transmission using a radio signal. This is in fact the most commonly used standard for data transmission via radio in the office, home, and industry sector.

The abbreviation LPWAN (Low Power Wide Area Network) refers collectively to different classes of network protocols for connecting low-energy devices such as battery-operated sensors to a server. The protocols are designed in such a way that a long range and low energy consumption of the terminal devices can be achieved to provide operating efficiency. Examples of LPWAN technologies are LoRaWAN, LTE-M, NB-IoT and Sigfox.

LoRaWAN, short for Long Range Wide Area Network (LoRaWAN), is a standard of the LoRa Alliance.

LTE-M and NB-IoT are radio standards which have been standardized by the 3GPP and a further available in the 4G mobile radiocommunication network and under 5G also. NB-IoT uses, for example, the mobile radio frequencies of the GSM-900 frequency band becoming free through the further development of mobile radio terminal devices incorporating higher frequency bands.

Sigfox is a proprietary radio system of the eponymous French company Sigfox SA, operating in the SRD band (868 Megahertz in Europe, 902 Megahertz in the USA).

All of the aforementioned standards can essentially be suitable for data transfer according to the present disclosure.

According to one or more implementations, the data transfer transceiver and the on-board data receivers can be configured for wireless data transfer. No cabling is required between the transmitter and receiver in wireless data transfer. This allows a flexible positioning/movement of the vehicles in relation to the data transfer transceiver without adversely affecting the data transfer or restricting freedom of movement due to mechanical components (such as cable connections).

According to one or more further implementations, the data transfer transceiver may include a data transceiver for transmitting the data packets to the on-board data receivers, and, if necessary, a data receiver. The aforementioned data transceiver can be understood to mean a radio transmitter which is configured to transmit data packets wirelessly. In addition, the data transfer transceiver may be a transceiver and include a data receiver in order, for example, to be able to receive and process data or data packets transmitted back by the vehicles (e.g. an on-board data transmitter). According to a further implementation, the vehicles in each case may additionally have an on-board data transmitter along with the respective on-board data receivers. The on-board data receivers and the on-board data transmitters can in each case constitute common structural units in the vehicles in the form of data communication units (i.e., radio transceivers).

According to a further implementation, the data packets in each case may include a data packet message body comprising message body data, and a data packet header comprising header information. As mentioned above, a data packet message body can contain payload data. A data packet header can contain header information of the data packet. The data packet message body can contain information relating to all vehicles which receive the data packet.

According to a further implementation, the data packet header may have one or more subheaders, wherein a subheader comprises administrative information such as address information, security information and/or other information as header information. Information of this type can be relevant to the autonomous driving operation or to specific driving tasks or driving maneuvers of the vehicle.

According to a further implementation, the security information may include coding information, authentication information, identification information and/or signature information. Coding information can relate to information which is required to read or open a data packet or which has to be decoded by the on-board receiver. Corresponding decoding information can be stored in the on-board receiver or can be made available to it separately. Authentication information can relate to the identity of the sender of the data packets, i.e., the identity of the data transfer transceiver. The identity or proof of identity of the sender can be checked on the basis of this information, for example through comparison with stored data. An identification relates to the identification of said sender, whereas an authentication provides a facility for verification. Coding information, authentication information or identification information of this type significantly increase data transfer security, but normally require on-board devices or means for the corresponding readout of the information concerned. Signature information can be understood to mean, for example, digital signatures (codes, stamps, etc.). The subheaders can also contain information relating to the version of the respective data transmission protocol (protocol version), an identifier of a respective data packet or a message (message ID), and an identifier of the dispatching data transfer transceiver (station ID).

According to a further implementation, the data packet message body may include information as message body data for an autonomous driving operation of the vehicles. This can be, for example, route information, status information for parking spaces (occupied, reserved, free), status information for charge points or filling stations (occupied, reserved, free), status information for loading and unloading stations (loading possible, loading not possible, unloading possible, unloading not possible, etc.), or other information which can influence the autonomous driving operation of a vehicle.

However, as message body data, the information for the autonomous driving operation of the vehicles preferably relates to limit value ranges for the speed (minimum speed, maximum speed) and for limiting the movement of the vehicle (in a transverse or longitudinal direction). The information for the autonomous driving operation can also comprise an expiry time which defines a time after which the vehicle must be stationary. A specific emergency driving maneuver, for example, and/or an emergency braking maneuver, such as an immediate emergency braking, can be instigated when the expiry time elapses. This information for the autonomous driving operation of a vehicle can be contained in a data container as part of the message body, wherein the data container is assigned to a specific vehicle, for example using an assignment identifier. In one advantageous design, this information for the autonomous driving operation of the vehicles is an optional component of a data container assigned to a specific vehicle.

According to a further implementation, the data packet message body may include task instructions for the vehicles as message body data. Particularly in the case where autonomously operated vehicles are used in “depot marshalling”, but in other applications also (e.g., the use of autonomous vehicles in a logistics center or on an industrial site), specific tasks can be predefined for the vehicles and can be incorporated, for example, into a higher-level task (e.g., a route to be travelled with specific tasks). Such tasks can relate to an action (e.g., stopping, parking, moving off, etc.) of the vehicle at a specific time at a specific location (a specific geo-position). However, autonomous driving commands for longitudinal and transverse guidance of the vehicle (i.e., direct control) can also be understood as task instructions. A task instruction can equally be an emergency message, wherein, after an emergency message of this type has been received, an emergency braking and/or emergency driving maneuver is triggerable in a specific vehicle or in all of the plurality of vehicles. Task instructions of this type can be contained in a data container as part of the message body, wherein the data container is assigned to a specific vehicle, for example using an assignment identifier. In one implementation, the task instructions form a mandatory component of a data container assigned to a specific vehicle.

According to a further implementation, the data packet message body may include map, environment, and/or traffic information as the message body data. Map information can relate to a predefined area in which a vehicle is moved, e.g., an industrial site, an urban area, etc. Map information can be map updates or the loading of new maps. Environment information can relate to information in the environment of a vehicle, for example the geo-position of specific functional units and infrastructure units, e.g., the geo-position of a filling station, charge point, or the like. Environment information can relate to weather information or weather conditions in relation to routes (wet conditions, icy conditions, etc.). Traffic information can relate, for example, to traffic volume, congestion information, traffic light settings, road condition, preferred routes, etc. Map information can also be understood to mean coordinates of route points on a route along which a specific vehicle makes an autonomous journey. The sequence of route points can form a trajectory which the vehicle is intended to follow in its longitudinal and transverse direction. Map, environment and/or traffic information of this type can be contained in a data container as part of the message body, wherein the data container is assigned to a specific vehicle, for example using an assignment identifier. In one advantageous design, the map, environment, and/or traffic information is an optional component of a data container assigned to a specific vehicle.

According to a further implementation, the data packet message body may include an assignment identifier which is assigned to a specific vehicle of the plurality of vehicles, and which enables an assignment of message body data in relation to a specific vehicle of the plurality of vehicles. The assignment identifier can include a plurality of individual identifiers, for example a mission identifier which assigns a specific driving task (mission) to a specific vehicle. A driverless journey, for example, from a start route point to an end route point can be defined as a mission. Other driving instructions/tasks can also relate to an assignment identifier. If the assignment identifier includes a plurality of individual identifiers, an individual identifier can also relate as a subidentifier to subtasks during the execution of a mission, for example stopping at a filling station or charge point, visiting a car wash, etc.

According to a further implementation, the data packet message body may include one or more data containers, wherein a respective data container is assigned to a specific vehicle of the plurality of vehicles, and wherein a data container assigned to a specific vehicle includes the assignment identifier assigned to the specific vehicle and message body data assigned to this vehicle.

According to a further implementation, the data transfer transceiver may be configured to transmit a data packet via the broadcast transmission, and the on-board data receivers are configured to receive and process the data packet. As mentioned, in a broadcast transmission of this type, the data transfer transceiver transmits a data packet once and said data packet is received by the respective on-board data receivers. A separate dispatch of data packets to each individual data receiver via point-to point connections is therefore not required. The data can be processed (e.g., preprocessed) by the data receiver and/or by downstream data processing units (e.g., of an on-board computer) to which the data are forwarded. It can be provided in a broadcast transmission of this type that a data packet is transferred to all on-board data receivers, but a specific vehicle does not read the data packet (e.g., if said vehicle is stationary).

According to a further implementation, the on-board data transmitters may be configured in each case to transmit response data packets to the data receiver of the data transfer transceiver, wherein the response data packets in each case include a response data packet message body comprising response message body data and a response data packet header comprising response header information, wherein the response data packet header has one or more response subheaders. The response data packet header or the response subheaders preferably contain the same data/information as the data packet header or the associated subheaders of the data packet transmitted from the data transfer transceiver via the broadcast transmission to the vehicles. The response message body data can relate to current status information of a specific vehicle, for example status information relating to an “activation of an autonomous driving operation”, current vehicle data such as a current speed, a current orientation of the vehicle, etc. The response message body can also contain the aforementioned assignment identifier. The response data packets can similarly be transmitted via a broadcast transmission from the respective on-board data transmitters to the data transfer transceiver (in this case, other vehicles can also receive the response data packet), or via end-to-end connections between the on-board data transmitters and the data transfer transceiver. A broadcast transmission of the response data packets also is advantageous since the response data packets can be transmitted to other receivers also, as well as to the data receiver of the data transfer transceiver.

According to a further implementation, the data transfer transceiver may be configured to transmit data packets periodically, such as at intervals of 50 ms, 100 ms, 150 ms, or 200 ms, to the on-board data receivers of the plurality of vehicles via the broadcast transmission. A continual data transfer in the direction of the data receivers of the vehicles can thus be guaranteed. A periodic transmission of data packets means that a data packet is transmitted at time intervals of e.g., 50 ms, 100 ms, 150 ms, or 200 ms. A short time interval enables particularly precise monitoring and control of an autonomous driving vehicle, whereas a longer time interval is advantageous in terms of reducing data capacities and computing capacities.

According to a further implementation, the on-board data transmitters may be configured in each case to transmit response data packets periodically, such as at intervals of 50 ms, 100 ms, 150 ms, or 200 ms to the data transfer transceiver. The transmission of the data packet and the transmission of the response data packets are preferably synchronized. This can mean that the data packets and response data packets are transmitted simultaneously, or with a defined temporal offset.

According to a further implementation, the data transfer transceiver and an on-board data communication unit of a respective vehicle may be configured to communicate the assignment identifier via a separate communication connection independently from the transmission of the data packets via the broadcast transmission. To do this, the assignment identifier can initially be transmitted from the data transfer transceiver to the on-board data communication unit or vice versa. The separate communication connection can be an end-to-end connection. The assignment identifier is preferably communicated via the separate communication connection in advance of the data packets transmitted via the broadcast transmission. If the assignment identifier comprises a plurality of individual identifiers, the plurality of individual identifiers can be communicated via the separate communication connection.

According to a further implementation, the data transfer transceiver may be configured to transmit an emergency message via the broadcast transmission to the on-board data receivers of the plurality of vehicles, wherein, following the reception of an emergency message of this type, an emergency braking and/or emergency driving maneuver is triggerable in a specific vehicle or in all of the plurality of vehicles. The transmission of the emergency message via the broadcast transmission preferably takes place immediately, i.e., without a time delay and independently from predefined time intervals. The emergency message can be part of a data packet message body. In the data packet message body, the emergency message can be present in the data container assigned to a specific vehicle, but also independently therefrom. In conjunction with the reception of an emergency message of this type, it can be provided in the respective vehicles that a braking system of the vehicle, such as a hydraulic braking system, is pre-activated (i.e., pre-loaded) so that a braking maneuver with the braking system is triggerable without a time delay.

In one or more implementations, a vehicle may include an on-board data receiver and optionally an on-board data transmitter, wherein the on-board data receiver and the on-board data transmitter preferably form an on-board data communication unit, and wherein the vehicle is configured for use in a system according to the present disclosure.

Finally, the present disclosure relates to a method for transferring data using data packets from a data transfer transceiver to a plurality of vehicles, comprising: transmitting a data packet using a broadcast transmission to on-board data receivers of the plurality of vehicles, the on-board data receivers receiving the data packet, and processing data contained in the data packet. Autonomous driving of the vehicles, such as along predefined travel routes within a predefined area, can be controlled by use of the transmitted data packets. This is achieved by use of a periodic transmission of data packets to the vehicles. Response data packets can equally be transferred by on-board data communication units to the data transfer transceiver, and this can similarly be performed periodically.

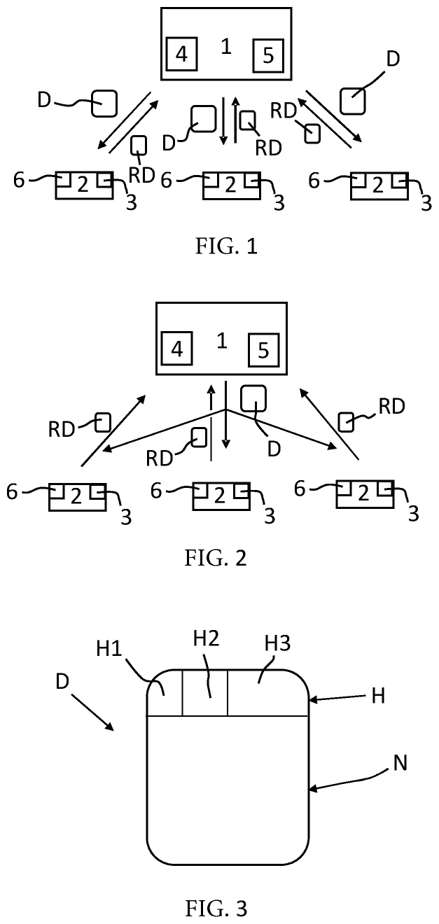

FIG. 1 shows a conventional system for transferring data using data packets D and response data packets RD, comprising a data transfer transceiver 1 and a plurality of vehicles 2.

The vehicles 2 in each case have an on-board data receiver 3 for receiving data packets D transmitted by the data transfer transceiver 1. The data transfer transceiver 1 has a data transceiver 4 for transmitting the data packets. In the system shown here, data packets D are transferred using point-to-point transmission between the data transfer transceiver 1 and the respective vehicles 2, i.e., using separate data connections. The vehicles 2 in each case further have an on-board data transmitter 6 by means of which response data packets RD can be transmitted to a data receiver 5 of the data transfer transceiver 1.

In contrast, FIG. 2 shows a system according to the present disclosure in which the data transfer transceiver 1 is configured to transmit the data packets D using a broadcast transmission to the on-board data receivers 3 of the plurality of vehicles 2. A data packet D is thus transmitted once (from a data transceiver 4 of the data transfer transceiver 1) and is received by all vehicles 2 using the on-board data receivers 3. This has an advantageous effect on the bandwidth load in the transmission of the data packet D, on the computing capacity of the data transfer transceiver 1 and on the computing time of the data transfer transceiver 1. The data transmission is performed wirelessly. Along with the on-board data receivers 3, the vehicles 2 in each case have an on-board data transmitter 6 with which response data packets RD are transmitted to a data receiver 5 of the data transfer transceiver 1.

FIG. 3 shows a schematic structure of a data packet D which is transmitted according to the present disclosure via a broadcast data transmission from the data transfer transceiver 1 to the vehicles 2. The data packet D in each case comprises a data packet message body N and a data packet header H. The data packet header H has one or more subheaders H1, H2, H3, wherein a subheader H1, H2, H3 comprises administrative information such as address information, security information and/or other information. The data packet message body N comprises information for an autonomous driving operation of the vehicles 2, i.e., for a plurality of vehicles 2. In contrast, in a conventional system (FIG. 1), message bodies N in data packets D normally comprise information for a specific vehicle 2 only.

The data packet message body N comprises information for an autonomous driving operation of the vehicles 2, task instructions for the vehicle 2, and map, environment and/or traffic information. Said security information comprises coding information, authentication information, identification information and/or signature information. The information for the autonomous driving operation of the vehicles 2, the task instructions for the vehicles 2 and the map, environment and/or traffic information can be contained together in a data container C (cf. FIG. 5) which is assigned to a specific vehicle 2 (e.g., using an assignment identifier). Similarly, the assignment identifier is preferably contained in said data container C. The message body N can comprise a plurality of data containers C which are assigned in each case to different vehicles 2, for example using corresponding assignment identifiers.

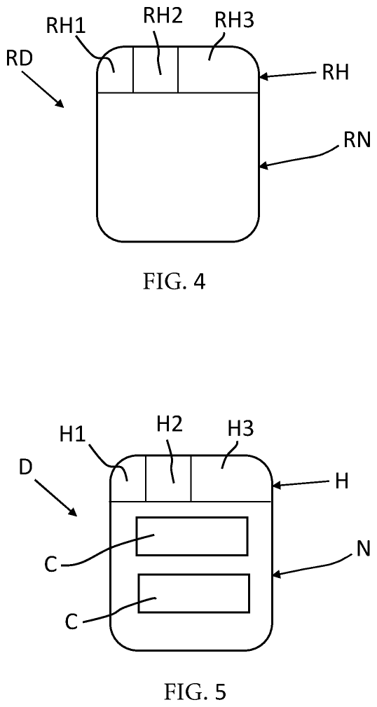

FIG. 4 shows schematically the structure of a response data packet RD. As mentioned, the on-board data transmitters 6 are configured in each case to transmit response data packets RD to the data receiver 5 of the data transfer transceiver 1. The response data packets RD in each case comprise a response data packet message body RN comprising response message body data and a response data packet header RH comprising response header information, wherein the response data packet header RH has three response subheaders RH1, RH2, RH3. The response data packet header RH or the response subheaders RH1, RH2, RH3 preferably contain the same data/information as the data packet header H of the associated subheaders H1, H2, H3 of the data packet D transmitted from the data transfer transceiver 1 using the broadcast transmission to the vehicles 2. The response message body data relate to current status information of a specific vehicle, for example status information relating to an “activation of an autonomous driving operation”, current vehicle data such as a current speed, a current orientation of the vehicle 2 in relation to a driving trajectory, etc. The response message body RN can also contain the aforementioned assignment identifier. The response data packets RD are transmitted using a broadcast transmission from the respective on-board data transmitters 6 to the data transfer transceiver 1 (in this case, other vehicles 2 can also receive the response data packets). Alternatively, the response data packets RD are transferred via end-to-end connections between the on-board data transmitter 6 and the data transfer transceiver 1.

### REFERENCE SIGN LIST

1 Data transfer transceiver
2 Vehicle
3 On-board data receiver
4 Data transmitter (of the data transfer transceiver)
5 Data receiver (of the data transfer transceiver)
6 On-board data transmitter
D Data packet
C Data container
RD Response data packet
R.N. Response data packet message body
RH Response data packet header
N Data packet message body
H Data packet header
H1 Subheader
H2 Subheader
H3 Subheader
RH1 Response subheader
RH2 Response subheader
RH3 Response subheader

1-23. (canceled)

24. A system for transferring data using data packets, comprising:
a data transfer connection configured to receive data and information from infrastructure sensors; and
a data transfer transceiver configured to transmit data packets via a broadcast transmission,
wherein the data packets respectively include a data packet message body having message body data, and a data packet header including header information,
wherein the data packet header has one or more subheaders that include administrative information including address information and/or security information.

25. The system of claim 24, wherein the data transfer transceiver is configured for wireless data transfer.

26. The system of claim 24, wherein the data transfer transceiver comprises a data transmitter for transmitting the data packets.

27. The system of claim 24, wherein the data transfer transceiver comprises a data receiver for receiving return data packets.

28. The system of claim 24, wherein the data packets header includes security information that includes coding information, authentication information, identification information, and/or signature information.

29. The system of claim 24, wherein the data packet message body includes at least one of:
information for an autonomous driving operation of vehicles as message body data, task instructions for the vehicles as the message body data, or
map, environment, and/or traffic information as the message body data.

30. The system of claim 24, wherein the data packet message body includes an assignment identifier which is assigned to a specific vehicle of a plurality of vehicles, and that identifies message body data assigned to the specific vehicle of the plurality of vehicles.

31. The system of claim 30, wherein the data packet message body includes one or more data containers, wherein a respective data container is assigned to a specific vehicle of a plurality of vehicles, and wherein a data container assigned to the specific vehicle comprises the assignment identifier assigned to the specific vehicle and message body data assigned to the specific vehicle.

32. The system of claim 24, wherein a data receiver of the data transfer transceiver is configured to receive response data packets from a plurality of vehicles,
wherein the response data packets respectively include a response data packet message body including response message body data and a response data packet header including response header information, and
wherein the response data packet header has one or more response subheaders.

33. The system of claim 24, wherein the data transfer transceiver is configured to transmit data packets periodically at an interval of at least 50 ms via the broadcast transmission.

34. The system of claim 24, wherein the data transfer transceiver is configured to communicate an assignment identifier to an on-board data communication unit of a respective vehicle via a separate communication connection independent from the broadcast transmission.

35. The system of claim 24, wherein the data transfer transceiver is configured to transmit an emergency message via the broadcast transmission to trigger an emergency braking and/or emergency driving maneuver in a vehicle.

36. A method, comprising:
receiving, at a data transfer connection, data and information from infrastructure sensors; and
transmitting, from a data transfer transceiver, data packets via a broadcast transmission, wherein the data packets respectively include a data packet message body having message body data, and a data packet header including header information,
wherein the data packet header has one or more subheaders that include administrative information including address information and/or security information.

37. The method of claim 36, wherein the data packets header includes security information that includes coding information, authentication information, identification information, and/or signature information.

38. The method of claim 36, wherein the data packet message body includes at least one of:
information for an autonomous driving operation of vehicles as message body data, task instructions for the vehicles as the message body data, or
map, environment, and/or traffic information as the message body data.

39. The method of claim 36, wherein the data packet message body includes an assignment identifier which is assigned to a specific vehicle of a plurality of vehicles, and that identifies message body data assigned to the specific vehicle of the plurality of vehicles.

40. The method of claim 39, wherein the data packet message body includes one or more data containers, wherein a respective data container is assigned to a specific vehicle of a plurality of vehicles, and wherein a data container assigned to the specific vehicle comprises the assignment identifier assigned to the specific vehicle and message body data assigned to the specific vehicle.

41. The method of claim 36, wherein a data receiver of the data transfer transceiver receives response data packets from a plurality of vehicles,
wherein each of the response data packets includes a response data packet message body including response message body data and a response data packet header including response header information, and
wherein the response data packet header has one or more response subheaders.

42. The method of claim 36, wherein the data transfer transceiver communicates an assignment identifier to an on-board data communication unit of a vehicle via a separate communication connection independent from the broadcast transmission.

43. The method of claim 36, wherein the data transfer transceiver transmits an emergency message via the broadcast transmission to a plurality of vehicles to trigger an emergency braking and/or emergency driving maneuver in a vehicle.
